(19) United States
(12) Patent Application Publication
(10) Pub. No.: US 2002/0073182 A1
(43) Pub. Date: Jun. 13, 2002

(54) Method and apparatus for a smart DHCP relay

(76) Inventors: Maxim V. Zakurdaev, Nepean (CA); Robert W. Froehlich, McKinney, TX (US); Dinesh Pai, Plano, TX (US); Stephane S. Roch, Gatineau PQ (CA); Paul J. Shields, Plano, TX (US)

Correspondence Address: Garlick & Harrison, P.O. Box 670007, Dallas, TX, 75367, US

(21) Appl. No.: 09/733,426

(22) Filed: Dec. 8, 2000

(51) Int. Cl. G06F 15/177

(52) U.S. Cl. 709/220

(57) ABSTRACT

A Smart DHCP Relay server is formed for receiving all IP address requests, to determine the ISP to which the request should be forwarded, and then to forward the request to the ISP. Accordingly, when the ISP responds, the Smart DHCP Relay generates an IP address for delivery to the user terminal that initiated the request. The user terminal, upon receiving the one response, automatically loads the IP address for use whenever access to the Internet by way of the ISP equipment is desired. The system includes a gateway device that forwards all address requests (DHCPDISCOVER). The Smart DHCP Relay includes a database that maps MAC addresses with corresponding selected IP addresses from a number of ISPs offering a service to the subscribers. The duration that the MAC address is assigned to the IP address provided by the selected ISP is variable. It may be made to last only for a specified session or period. Alternatively, it can be made to last indefinitely.

### BACKGROUND

1. Technical Field

The present invention relates to computer networks and, more particularly, to a system and method for facilitating the provisioning of an Internet service provider Internet Protocol (IP) V4 address into a terminal or other computer equipment.

2. Related Art

Internet Service Provider (ISP) Dynamic Host Control Protocol (DHCP) specifies how IP addresses are entered into a specific register of a terminal's networking software driver, so the terminal can properly create and maintain a connection between the terminal and the ISP whenever a user of the terminal seeks access to the Internet through the equipment of the ISP. Accordingly, a traditional part of establishing service with a selected ISP is to enter, usually with the help of an ISP's technical support personnel, the settings and parameters required for the terminal to connect properly with the ISP equipment each time the user chooses to “surf the web.”

While this approach does not seem, in theory, too onerous, it often is a frustrating process as technical support technicians are overwhelmed with calls. It is not uncommon for one to have to wait hours while enduring annoying music and constant reminders that the call is important and will be picked as soon as possible. The problem becomes much worse when the end user decides to change an ISP or multiple users, subscribed to the different ISP use the same terminal one after another.

This is where DHCP protocol was defined in the IETF to facilitate a process that reduces the likelihood that a user will require the assistance of a technical support technician thereby reducing using frustration and enabling technical support personnel to lend their efforts to real problems.

Along these lines, software companies have created the capability (DHCP client) in their software for the terminal to automatically store the IP address and the associated parameters in the specified registers. The issue, however, includes delivering the IP address for the ISP of choice for automatic installation into the user terminal.

One solution that is being considered and, perhaps, tried is to forward an address request signal (DHCP Request) to all ISPs connected to the access network equipment communicating with the user terminal. One problem with this approach, however, is that most of the ISP equipment is programmed to automatically respond with an IP address whenever it detects such a request. Thus, a user terminal would be inundated with multiple responses to the issued DHCP single DHCP request. Accordingly, there is no guarantee that the proper IP address would be loaded into the computer terminal memory registers.

One solution to this problem would be to create a database within the equipment of each ISP to only respond to address requests from its own ISP account holders (customers). A problem with this approach, however, is that it is inefficient and would require significant maintenance effort by the ISPs. For these reasons, ISPs are not too eager to implement this solution. Also this method ties user terminal profile with a single ISP, which doesn't work in case of a shared terminal or change of a terminal by the user.

Another proffered solution is to create one very large database including DHCP addresses of all ISP service subscribers at a network operations center (NOC). Thus, the database includes a mapping between user terminals and all of the corresponding ISP information including the IP addresses of the ISP. This approach is not desirable because of the significant maintenance requirements. Not only would user ISP preferences be stored, but also all of the corresponding ISP information. Accordingly, updates are required when ISP information or user preferences change.

What is needed, therefore, is a method and apparatus that supports automatic generation of a user selected ISP IP address and delivery of the same to the user's terminal for automatic loading/installation.

### SUMMARY OF THE INVENTION

A Smart DHCP Relay proxy server is placed between the user terminal and the ISP formed forto receiving receive all IP address requests, and more particularly, DHCP address requests, to determine the ISP to which the request should be forwarded, based on the user preferences and supplied credentials and then to forward the request to the ISP. Accordingly, the ISP equipment responds, upon receiving the forwarded request, and generates an IP address for delivery to the user terminal that generated the request. The user terminal, upon receiving the one response, automatically loads the IP address for use whenever access to the Internet by way of the ISP equipment is desired.

More particularly, the system includes a gateway device that forwards all IP address requests to the Smart DHCP Relay regardless of what system is requesting an address. The gateway device further receives and forwards a DHCP response to the system that previously requested the address. In one embodiment of the present invention, a temporary address is assigned to the system requesting the address for identifying the system and for delivering the address to it.

A Smart DHCP Relay includes a database that maps user equipment (terminal) identity or user account information with a select Internet Service Provider. In one embodiment, whenever an end user (or a subscriber) selects an ISP, the ISP updates the Smart DHCP Relay proxy server. Accordingly, the first time the subscriber equipment is initialized and connected to the network, the Smart DHCP Relay receives an IP address request from the gateway device, which address request was generated by the subscriber equipment. The IP address request includes an identifier that uniquely identifies the subscriber and/or the subscriber equipment. Accordingly, the Smart DHCP Relay identifies the select ISP and forwards the address request to it. The ISP then responds by generating and transmitting an IP address to the subscriber equipment.

### BRIEF DESCRIPTION OF THE DRAWINGS

A better understanding of the present invention can be obtained when the following detailed description of the preferred embodiment is considered with the following drawings, in which:

FIG. 1 is a functional block diagram illustrating a prior art communication network.

FIG. 2 is a signal sequence diagram illustrating system operation in a network formed according to one embodiment of the present invention.

FIG. 3 is a functional block diagram illustrating a system for automatically loading an IP address in a user terminal.

FIG. 4 is a flow chart illustrating a method for automatically loading an IP address into a user computer terminal.

FIG. 5 is a functional block diagram of a Smart DHCP Relay formed according to one embodiment of the present invention.

### DETAILED DESCRIPTION OF THE DRAWINGS

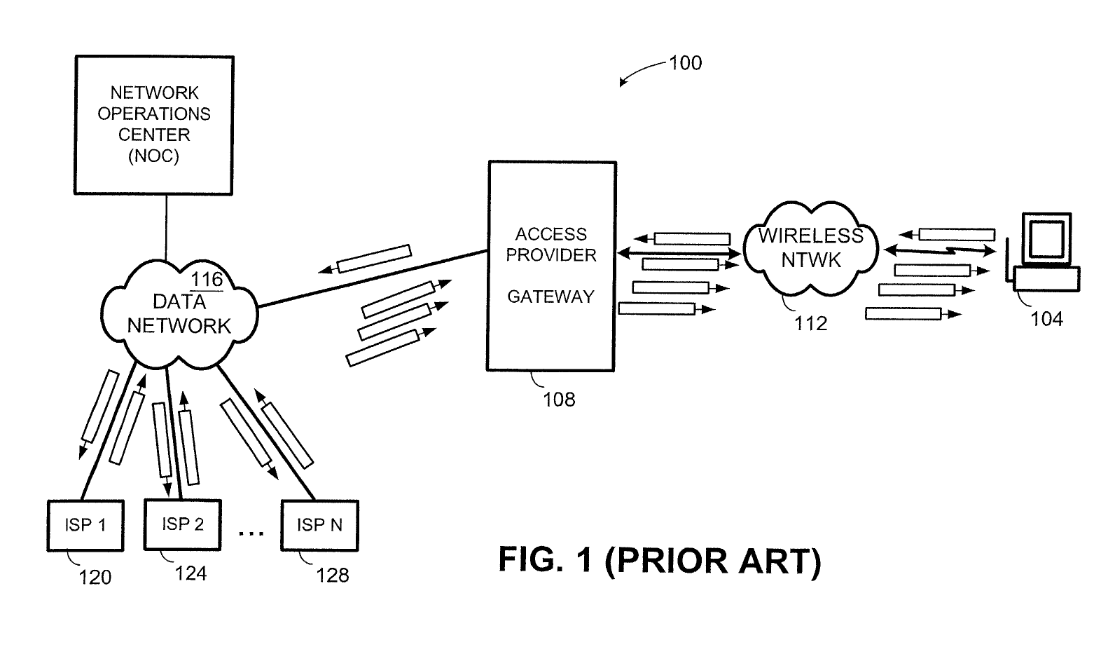

FIG. 1 is a functional block diagram illustrating a prior art communication network. In particular, FIG. 1 illustrates a shortcoming of prior art network that may be used to attempt to automatically load an IP address into a user terminal. As may be seen, an address request is transmitted from the user computer terminal 104 to a gateway system 108 by way of a local access network 112. The gateway system then forwards the address request in a broadcast mode through a data network 116 to each of a plurality of N ISP servers 120-128.

Responsive to receiving an IP address request, each of the ISP servers 120-128 respond to the user terminal with an ISP address for automatic loading and storage at the user terminal. Accordingly, as may be seen, N ISP addresses are transmitted to the user computer terminal, if ISPs choose to automatically respond to the address request.

How the user terminal responds may vary. For example, it may accept only the first address received. Alternatively, it may replace each stored address with each new address received. Accordingly, the one certain aspect of this approach is that the user computer terminal may receive and store an IP address, but, more than likely, it will not be the one, desired by the user.

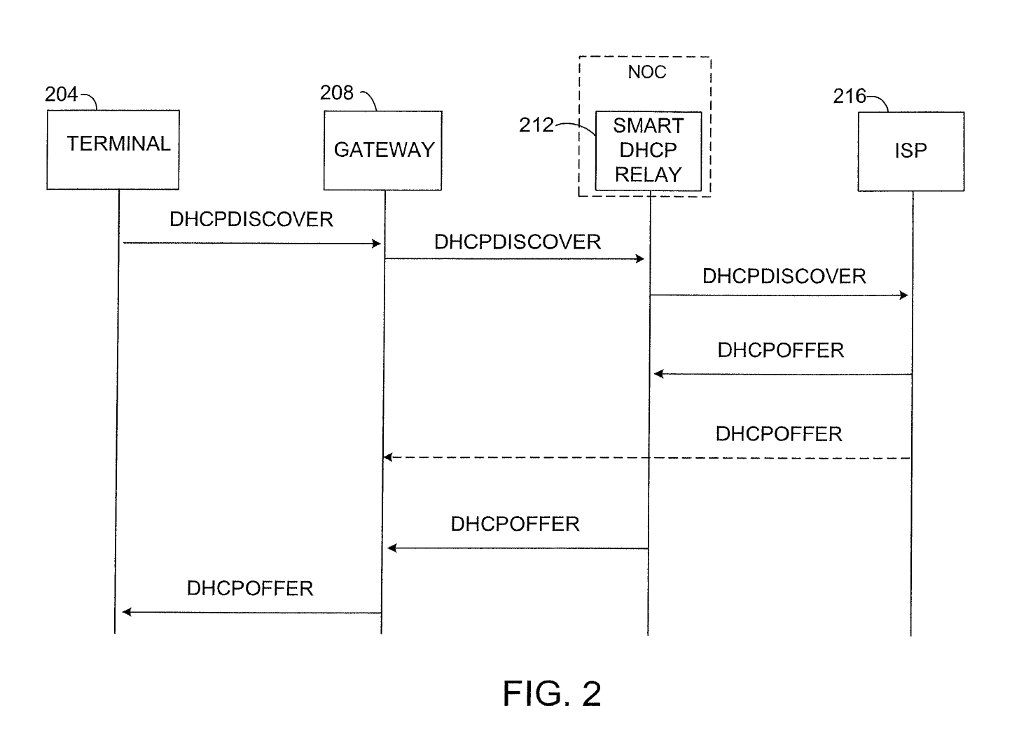

FIG. 2 is a signal sequence diagram illustrating system operation in a network formed according to one embodiment of the present invention. Referring now to FIG. 2, a user terminal 204 initially transmits an IP address request to a gateway device 208. In the described embodiment of the present invention, the address request is a signal referred to a DHCPDISCOVER signal as defined in the Internet Engineering Task Force Request for Comments (IETF RFC) standard. One purpose of the DHCDISCOVER signal is to request an IP address of the ISP that is to provide Internet access service to the user. Typically, the DHCPDISCOVER signal is a broadcast signal that is automatically generated by a user terminal network interface card (NIC). The NIC card transmits its Media Access Control (MAC) address as a part of the DHCPDISCOVER signal or other IP address request signal.

The gateway device 208, upon receiving the address request or DHCPDISCOVER signal, analyzes it to determine that it is a DHCPDISCOVER signal, and responsive thereto, forwards the received DHCPDISCOVER signal to a Smart DHCP Relay 212. In one embodiment of the present invention, the Smart DHCP Relay 212 is formed as a part of a Network Operations Center (NOC) as is suggested by the dashed box around relay 212. In alternate embodiment, relay 212 may be formed as a separate entity or as a part of a different system.

The Smart DHCP Relay 212, upon receiving the DHCPDISCOVER signal, analyzes it to discover one of a user ID, a user terminal ID or a terminal MAC address to determine the IP address of the DHCP Server of a the corresponding ISP. Once the Smart DHCP Relay 212 determines the IP address of the corresponding ISP, it forwards the DHCPDISCOVER signal to the corresponding ISP 216.

The corresponding ISP 216, upon receiving the DHCPDISCOVER signal, generates a DHCPOFFER signal that is transmitted back to the Smart DHCP Relay 212. The Smart DHCP Relay 212, upon receiving the DHCPOFFER signal, stores (maps) an IP address for the ISP server 216 to a subscriber MAC address. Thereafter, the IP address 216 is forwarded to the user computer terminal 204 for automatic loading.

In an alternate embodiment of the invention, the ISP DHCP server 216 generates a response signal containing its own IP address that the user terminal 204 is to use when seeking renewal of the assigned (or “leased”) IP address. This response signal is transmitted directly to the user terminal by way of gateway device 208. In this embodiment of the present invention, the response signal is a DHCPOFFER signal, but unlike before, it is transmitted directly to the user terminal. The DHCPOFFER signal, here, also includes the IP address of the ISP DHCP server.

In one embodiment of the present invention, the mapping between the MAC address and the ISP 216 identified in the DHCPOFFER signal lasts until changed meaning that the allocation is reserved for the particular user until the relationship between the ISP and the user is terminated.

In an alternative embodiment, the mapping occurs only for a given session. In yet another alternative embodiment, the mapping occurs only for a specified period or number of sessions. Thereafter, the IP address is released for use by another user computer terminal.

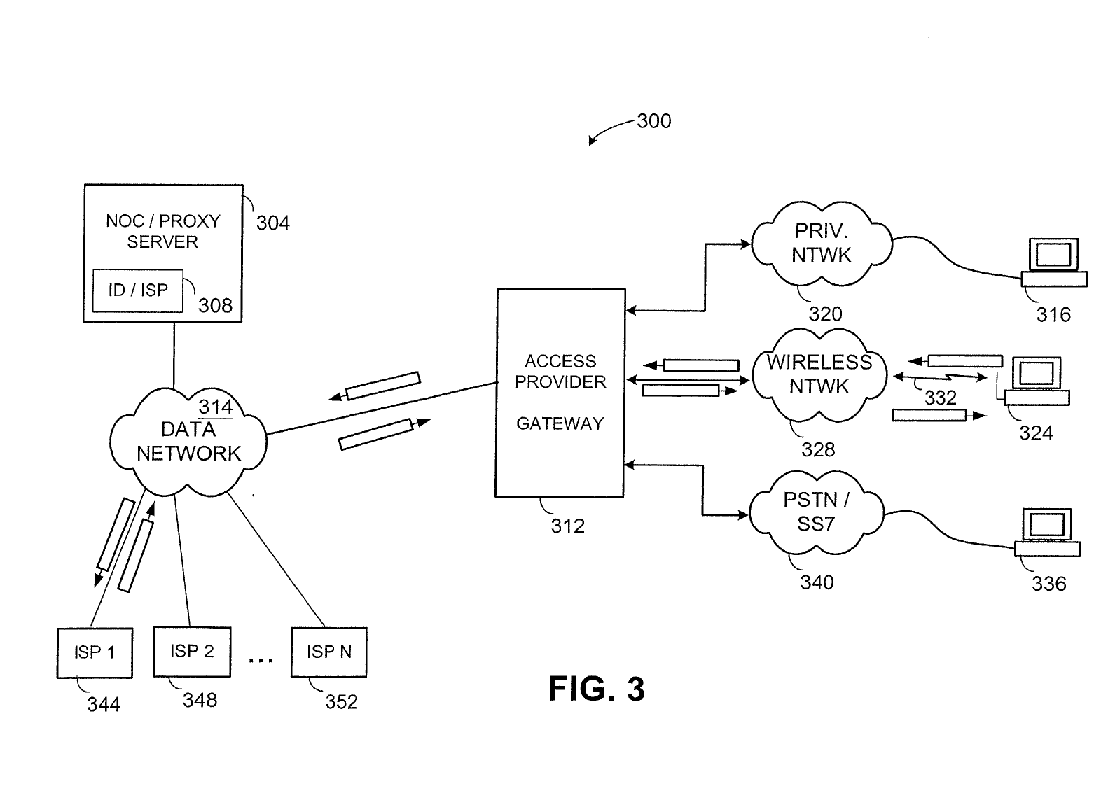

FIG. 3 is a functional block diagram illustrating a network that includes a system for automatically loading an IP address in a user terminal according to one embodiment of the present invention. A network 300 includes a Network Operations Center (NOC) 304 for controlling network operations as is suggested by its name. NOC 304 includes a database 308 for mapping user IDs with selected Internet service providers. The user ID may be in the form of an account number, a terminal ID or MAC address or an ID of any other form. The ISP is, in one embodiment of the invention, identified by its IP address at a minimum.

A gateway device 312 is coupled to communicate with NOC 304 by way of a data packet network 314 as well as with a plurality of user terminals by way of a plurality of networks. For example, gateway device 312 is coupled to communicate with user terminal 316 by way of a private network 320. Private network 320 may comprise, for example, a corporate local area network.

Gateway device 312 also is coupled to a wireless terminal 324 by way of a wireless network 328. A wireless link 332 carries the communication signals between wireless user terminal 324 and wireless network 328. Finally, gateway device 312 is coupled to a user terminal 336 by way of a telephone network 340. Telephone network 340 includes conventional public switched telephone networks (PSTNs) as well as SS7 and other similar intelligent networks (IN).

As may also be seen, gateway device 312 also is coupled to communicate with a plurality of ISPs 344, 348 and 352 representing up to N ISPs by way of data packet network 314. Each of the users of user terminals typically selects one of the ISPs 344, 348 and 352 to provide Internet access service. The issue, therefore, is to create a system for automatically loading an ISP's IP address utilizing the auto-loading capability of the user's user terminal.

In operation, a user terminal generates an address request that is transmitted to a gateway device. By way of example, user terminal 324 generates an address request signal through the local access network 328 to the gateway device 312. The gateway device 312 analyzes the signal and identifies it as an IP address request signal. In one embodiment of the present invention, the address request signal is a DHCPDISCOVER signal.

Upon identifying the IP address request signal, gateway device 312 forwards the signal to the NOC 304. NOC 304, upon receiving the address request signal, examines the contents of database 308 to determine a selected ISP for the user terminal 324. Upon determining the selected ISP, for example, ISP 344, NOC 304 forwards the address request signal to the ISP 344. If the address request signal is a DHCPDISCOVER signal, then the DHCPDISCOVER signal is forwarded to ISP 344.

Upon receiving the DHCPDISCOVER signal or the address request signal, ISP 344 responds with a DHCPOFFER signal. In the described embodiment of the invention, the DHCPOFFER signal is transmitted to NOC 304 where the ISP's IP address is mapped with the user terminal's MAC address. Thereafter, the ISP's IP address is transmitted to user terminal 324 by way of gateway device 312 and local access network 328. It is understood, of course, that alternatives exist to the ways of transmitting a DHCPOFFER signal from the ISP DHCP server 344.

In general, a signal is transmitted by the ISP DHCP server 344 that indicates a willingness (ability) to provide service to the user terminal 324. One advantage of the system and network of FIG. 3 is that only the selected ISP server 344 receives the DHCPDISOCOVER signal. In the present example of the invention shown in FIG. 3, ISP DHCP servers 348 and 352 do not receive the DHCPDISOCOVER signal.

While the network of FIG. 3 illustrates one gateway device 312, many other gateway devices 312 may be included. For example, each of the networks 320, 328 and 340 may have a dedicated gateway device. Additionally, private networks such as network 320 may include a firewall between the gateway device 312 and the private network. Alternatively, the gateway device and firewall may be combined as one system. Only one gateway device 312 is shown herein for simplicity.

The operation of the network of FIG. 3 is illustrated by the sequentially numbered signals transmitted through the network. As may be seen, an IP address request signal 1 is transmitted by the user terminal 324 to the local access network 328. From there, address request signal 2 is transmitted to the gateway device 312. Gateway device 312 forwards the address request signal 3 to data network 314 which in turn forwards address request signal 4 to NOC 304. NOC 304 then transmits the address request signal 5 to data network 314 where address request signal 6 is then routed to the ISP 344.

ISP 344 responds with a DHCPOFFER signal 7 that is transmitted to data network 314. Because of the aforementioned alternatives, only a DHCPOFFER signal 8 is shown being transmitted from data network 314 to gateway device 312. As was explained already, the DHCPOFFER signal may be sent directly to the user terminal or it may be send to NOC 304 first. If it is sent to NOC 304 first, NOC 304 then transmits the DHCPOFFER signal to indicate that resources are allocated to the user terminal as identified by its MAC address.

The DHCPOFFER signal 8 is then received by gateway device 312 and is forwarded to the wireless network as DHCPOFFER signal 9 and then to the user terminal 324 as DHCPOFFER signal 10.

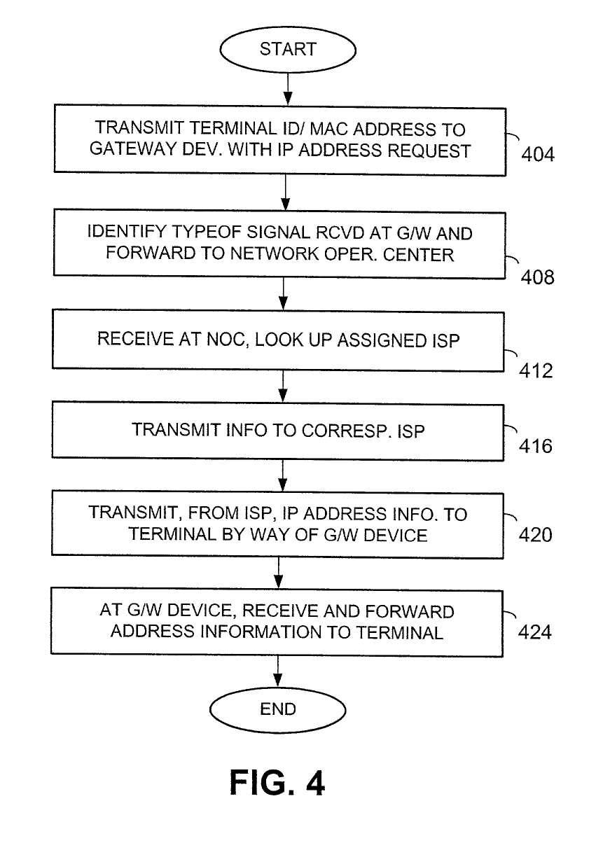

FIG. 4 is a flow chart illustrating a method for automatically loading an IP address into a user computer terminal. Initially, a terminal ID (or MAC address) is transmitted to a gateway device by a user terminal along with a request for the IP address from its ISP (step 404). In one embodiment of the invention, the transmitted signal is a DHCPDISCOVER signal. Thereafter, the gateway device, upon receiving the signal, identifies it and forwards it to a network operations center (NOC) for processing (step 408). The NOC, in turn, determines the identity (IP address) of a select (assigned) ISP (step 412). In the described embodiment, the NOC includes a database that maps MAC addresses to the selected IP addresses.

Thereafter, the NOC transmits the DHCPDISCOVER signal to the selected ISP to prompt the ISP to respond with an IP address for the user terminal (step 416). Accordingly, the ISP responds with IP address information for use by the user terminal to enable it to access the Internet using the assigned IP address. More specifically, the ISP sends IP address information to the user terminal by way of the gateway device (step 420). The gateway device, in turn, receives the transmission from the ISP and forwards the ISP's IP address to the user terminal (step 424). In the described embodiment of the invention the response is a DHCPOFFER signal.

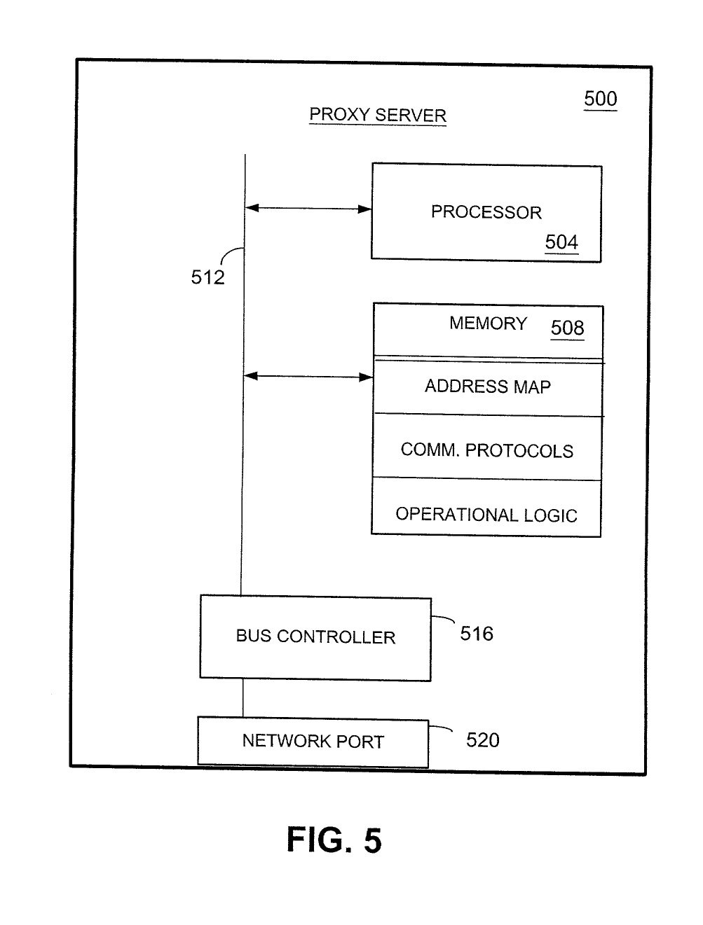

FIG. 5 is a functional block diagram of the DHCP Relay formed according to one embodiment of the present invention. Referring now to FIG. 5, the DHCP Relay 500 includes a processor 504 that is coupled to receive computer instructions stored in a memory 508 by way of a bus 512. Bus 512 further is coupled and is controlled by a bus controller 516. Bus controller 516 also is coupled to a network port 520. Accordingly, processor 504 also is able to transmit and to receive transmissions for processing through network port 520 by way of bus 512 and bus controller 516.

The computer instructions stored within memory 508 define the operational logic of the Smart DHCP Relay including the logic for creating a database for mapping user terminal MAC addresses with the ISPs' IP addresses. The computer instructions further define logic for communication protocols for communicating over the network port 520. Finally, the computer instructions also define all other operational logic of the Smart DHCP Relay 500. With respect to the operational logic of Smart DHCP Relay 500, the computer instructions define logic that, among other tasks, enable a system to perform the methods and processes described herein this application.

The inventive method and apparatus disclosed herein are particularly advantageous in that they provide a capability for automatically loading IP addresses into a user's terminal. Thus, the process of establishing a new account with a new ISP is facilitated reducing the number of problems that may be encountered and the amount of time required to achieve the same. Additionally, technical support resources are freed for use in tackling other and perhaps more significant problems.

While the invention is susceptible to various modifications and alternative forms, specific embodiments thereof have been shown by way of example in the drawings and detailed description. It should be understood, however, that the drawings and detailed description thereto are not intended to limit the invention to the particular form disclosed, but on the contrary, the invention is to cover all modifications, equivalents and alternatives falling within the spirit and scope of the present invention as defined by the claims. As may be seen, the described embodiments may be modified in many different ways without departing from the scope or teachings of the invention. For example, any combination of the described methods may be combined to create an inventive system that supports auto-loading of an IP addresses into a user's terminal.

1. A method for auto-loading an IP address into a user terminal, comprising:
transmitting an IP address request signal from the user terminal to a gateway device;
transmitting the IP address request signal from the gateway device to a network operations center (NOC);
determining a corresponding ISP selected for assigning an IP address for the user terminal;
transmitting the IP address request signal from NOC to the ISP;
transmitting, from the ISP to the gateway device, a response signal comprising an IP address for usage by the user terminal; and
transmitting, from the gateway device, the response signal to the user terminal.

2. The method of claim 1 wherein the IP address request signal comprises a DHCPDISCOVER signal.

3. The method of claim 1 wherein the response signal comprises a DHCPOFFER signal.

4. The method of claim 1 wherein the IP address request signal comprises a DHCPDISCOVER signal and wherein the response signal comprises a DHCPOFFER signal.

5. The method of claim 1 wherein the response signal is transmitted to the gateway device by way of the NOC.

6. The method of claim 5 wherein the NOC maps the user terminal's MAC address to the IP address of the selected ISP.

7. The method of claim 6 wherein the NOC maps the MAC address to the IP address of the selected ISP for a defined session.

8. The method of claim 6 wherein the NOC maps the MAC address to the IP address of the selected ISP for a defined period.

9. The method of claim 6 wherein the NOC maps the MAC address to the IP address of the selected ISP for an indefinite period until a change is entered into the NOC.

10. A method in a Network Operations Center (NOC) for auto-loading an IP address form the selected ISP into a user's terminal, comprising:
receiving a DHCPDISCOVER signal from the user's terminal;
determining a corresponding ISP for the IP address to be assigned to the user terminal;
informing the ISP of the DHCPDISCOVER signal;
receiving a DHCPOFFER signal from the ISP; and
transmitting the ISP's IP address to the user's computer terminal so that its software can automatically load the IP address.

11. The method of claim 10 further including the step of storing, within a database formed within or coupled to the NOC, a MAC address for the user's terminal in relation to the IP address.

12. The method of claim 11 wherein the MAC address is stored in relation to the IP address from the elected ISP for a specified session.

13. The method of claim 11 wherein the MAC address is stored in relation to the IP address form the selected ISP for a specified period.

14. The method of claim 11 wherein the MAC address is stored in relation to the IP address from the selected ISP for an indefinite period and until changed.

15. A Smart DHCP Relay, comprising:
a processor;
an internal bus; and
a memory for storing computer instructions, which computer instructions define the logical operation of the proxy server, the logical operation including logic to prompt the Smart DHCP Relay to:
receive address request signals generated by user terminals;
for each address request signal, determine a corresponding ISP; and
prompt the corresponding ISP to respond to the address request signal.

16. The Smart DHCP proxy Relay server of claim 15 wherein the computer instructions further define operational logic to process an IP address request signal transmitted as a DHCPDISCOVER signal.

17. The Smart DHCP Relay of claim 15 wherein the computer instructions further define operational logic to process a response signal transmitted by the ISP.

18. The Smart DHCP Relay of claim 15 wherein the computer instructions further define operational logic to process a response signal transmitted by the ISP in the form of a DHCPOFFER signal.

19. The Smart DHCP Relay of claim 18 further including computer instructions that define logic to prompt the Smart DHCP Relay to store a MAC address for the user terminal in relation to the IP address of the selected ISP.

20. The Smart DHCP proxy Relay server of claim 19 further including computer instructions that define logic to prompt the proxy server to transmit the response DHCPOFFER signal to the user terminal.
